(19) United States
(12) Patent Application Publication
(10) Pub. No.: US 2026/0193930 A1
(43) Pub. Date: Jul. 9, 2026

(54) MODULAR FENESTRATION SYSTEM

(71) Applicants: Dion Der sarkissian, Passadena, CA (US); Arin Der sarkissian, Toluca Lake, CA (US)

(72) Inventors: Dion Der sarkissian, Passadena, CA (US); Arin Der sarkissian, Toluca Lake, CA (US)

(21) Appl. No.: 19/013,939

(22) Filed: Jan. 8, 2025

(51) Int. Cl. E06B 1/36; E06B 1/60

(52) U.S. Cl. CPC E06B 1/36; E06B 1/6015

(57) ABSTRACT

A modular fenestration system includes a first fenestration module having a perimeter with a number of though-holes having a first alignment, a second fenestration module comprising a perimeter with a number of through-holes having a second alignment differing from the first alignment, and a number of module couplers affixed along the perimeter of the second fenestration module. The module couplers have through-holes positioned to align with the though-holes in the second fenestration module having the second alignment and blind holes aligned with the through-holes in the first fenestration module having the first alignment. The module couplers are adapted for releasably joining the first fenestration module directly to the second fenestration module, enabling selective assembly, disassembly, reconfiguration, and reinstallation of compound fenestrations.

### FIELD OF THE INVENTION

The present invention relates to a modular fenestration system having a multi-component construction, including one or more door units and/or one or more window units, that enables assembly of compound fenestrations of selectively customizable configurations.

### BACKGROUND OF THE INVENTION

Fenestrations, including doors and windows, are a common element in the construction of modern buildings, traditionally serving as means of securing entryways to keep out unauthorized persons, protecting inhabitants from inclement weather and other external elements, and providing seclusion and privacy. In modern construction, fenestrations are commonly made to provide visual appeal and aesthetic expression of buildings. This has led to considerable variance, for example, in the construction of doors and windows from one building to another.

It is common to construct ornate fenestrations that combine one or more doors with one or more windows, for example, laterally along the door (sidelite) or vertically above the door (transom). Such fenestrations, combining one or more doors with one or more windows, may be referred to herein as “compound fenestrations”. Conventionally, compound fenestrations are constructed with a single composite frame with individual reception cavities for each door and window. FIGS. 1A-1D show examples of composite frames 1A-1C that may be used in compound fenestrations 10.

FIG. 1A shows an example of a compound fenestration 10 having a door unit 2 in the form of a double-door 2 with two window units 3A/3B, in the form of sidelites 3A/3B, one at each lateral side of the double-door, and FIG. 1B shows the composite frame 1A for the compound fenestration 10 of FIG. 1A, with omission of the double-door 2 and sidelites 3A/3B. The composite frame 1A is assembled with two vertical jambs 4A/4B defining the outer lateral perimeter of the composite frame 1A, two vertical mullposts 5A/5B defining vertical boundaries between the double-door cavity 6 and the sidelite cavities 7A/7B, a header 8 defining the upper boundary of the composite frame 1A, and a threshold 9 defining the lower boundary of the composite frame 1A. In a composite frame, a single continuous header 8 and a single continuous threshold 9 extend between the jambs 4A/4B and support the mullposts 5A/5B. The doors 2A/2B in the double-door 2 each have a lock stile 21A/21B where one or more locking mechanisms 22A/22B are installed, a hinge stile 23A/23B where door hinges 24 are mounted, a top rail 25A/25B extending between upper ends of the stiles 23A/23B and a bottom rail 26A/26B extending between bottom ends of the stiles 23A/23B. The sidelites 3A/3B each have a pair of vertical stiles 31A/31B, a top rail 32 extending between upper ends of the stiles 31A/31B and a bottom rail 33 extending between lower ends of the stiles 31A/31B. The double-door 2 is installed in the door cavity 6 of the composite frame 1A by mounting the door hinges 24 to corresponding mullposts 5A/5B, and the sidelites 3A/3B are installed in the sidelite cavities 7A/7B by securing the stiles 31A/31B to the surrounding jambs 4A/4B and the top rails 32 to the header 8.

The conventional practice when constructing compound fenestrations presents a drawback by requiring the inclusion of one or more mullposts, as the configuration of the doors and windows must be determined in advance without an option for readily switching the chosen configuration without replacing the composite frame. For example, if a compound fenestration is to be made with one or more doors and a single sidelite to a left of the door(s), then a composite frame 1B must be made with a mullpost 5A positioned to the left of a door cavity 6, as shown in FIG. 1C; and if a compound fenestration is to be made with one or more doors and a single sidelite to a right of the door(s), then a composite frame 1C must be made with a mullpost 5B positioned to the right of a door cavity 6, as shown in FIG. 1D. Once a composite frame 1B/1C is constructed, there is then no option for a user to readily reconfigure the fenestration, for example, by repositioning a sidelite from the left to the right of the door(s), or vice versa. If desiring to reconfigure a compound fenestration, a user will have to remove the existing composite frame 1B/1C for the current configuration and install a new composite frame 1C/1B for the desired configuration. Thereafter, any future reconfiguration of the compound fenestration will again require removing the then existing composite frame and installing a newly constructed composite frame.

It would thus be beneficial to have a modular fenestration system that enables assembly of compound fenestrations in a multitude of configurations, while also readily permitting selective reconfiguration of the compound fenestration without requiring removal and replacement of a composite frame.

### SUMMARY OF THE INVENTION

A modular fenestration system comprises a first fenestration module comprising a perimeter formed with a beam configuration having a distal web with a number of though-holes formed through the distal web, the number of through-holes having a first alignment; a second fenestration module comprising a perimeter formed with a beam configuration having a distal web with a number of though-holes formed through the distal web, the number of through-holes having a second alignment differing from the first alignment; wherein a number of module couplers are affixed along the perimeter of at least the second fenestration module, the module couplers having through-holes therethrough and positioned such that the though-holes in the module couplers are aligned with the through-holes in the distal web of the second fenestration module having the second alignment, the module couplers adapted for releasably joining the first fenestration module directly to the second fenestration module.

The module couplers have blind holes therein and are positioned such that the blind holes in the module couplers are aligned with the through-holes in the distal web of the first fenestration module having the first alignment. The blind holes in the modular couplers comprise internal threading for releasable reception of a matingly threaded fasteners. The through holes in the module couplers are non-threaded for unhindered passage of fasteners therethrough. The module couplers are configured for releasably joining the first fenestration module to the second fenestration module via reception of fasteners that pass through the through-holes in the first fenestration module and are secured within the blind holes of the module couplers. The module couplers are configured for releasably joining the second fenestration module to a frame in a rough opening of a structure via reception of fasteners that pass through the through-holes in the second fenestration module, pass through the through-holes in the module couplers, and are secured at the frame.

In examples according to the present invention, at least one of the fenestration modules in the modular fenestration system is a door unit and at least one other of the fenestration modules is a window unit. The window unit may be a sidelite adapted for releasably joining directly with the door unit, selectively, at both a lateral left position and a lateral right position of the door unit. The window unit may be a transom adapted for releasably joining directly with the door unit at a vertical position of the door unit.

Modular fenestration systems according to the present invention may be used to assemble compound fenestrations by joining a first fenestration module directly to a second fenestration module via a coupling configuration at the module coupler. The joined first fenestration and second fenestration may be secured in a pre-installed frame within a rough opening of a structure, the frame being free of an intermediate post or beam for positioning between the first fenestration and the second fenestration. A compound fenestration assembled in such a manner is adapted for selective reconfiguration, enabling repositioning of the relative positions of the first fenestration and the second fenestration within the frame without need for alteration to the frame. Such a compound fenestration is thus adapted for selective reconfiguration, for example, enabling reconfiguration from a door unit with a single window unit installed as a left-positioned sidelite to a door unit with a single window unit installed as a right-positioned sidelite.

Both the foregoing general description and the following detailed description are exemplary and explanatory only and are intended to provide further explanation of the invention as claimed. The accompanying drawings are included to provide a further understanding of the invention; are incorporated in and constitute part of this specification; illustrate embodiments of the invention; and, together with the description, serve to explain the principles of the invention.

### BRIEF DESCRIPTION OF THE DRAWINGS

Further features and advantages of the invention can be ascertained from the following detailed description that is provided in connection with the drawings described below:

FIGS. 1A-1D show composite frames for conventional compound fenestrations, in which: FIG. 1A shows a compound fenestration in a composite frame; FIG. 1B shows a composite frame for a door unit and two sidelites; FIG. 1C shows a composite frame for a door unit and a single left sidelite; and FIG. 1D shows a composite frame for a door unit and a single right sidelite.

FIGS. 2A-2C show a door unit according to the present invention, in which: FIG. 2A shows a front elevation view of the door unit; FIG. 2B shows a cross-sectional view of the door unit as seen along line IIB in FIG. 2A; and FIG. 2C shows a cross-sectional view of the door unit as seen along line IIC in FIG. 2A.

FIGS. 3A-3C show a window unit according to the present invention, in which: FIG. 3A shows a front elevation view of the window unit; FIG. 3B shows a cross-sectional view of the window unit as seen along line IIIB in FIG. 3A; and FIG. 3C shows a cross-sectional view of the window unit as seen along line IIIC in FIG. 3A.

FIGS. 4A-4B show a module coupler according to the present invention, in which FIG. 4A shows a front isometric view of the module coupler; and FIG. 4B shows a cross-sectional view of the module coupler as seen along line IVB in FIG. 4A.

FIG. 5 shows a coupling configuration for joining a door unit and a window unit.

FIG. 6 shows a coupling configuration for joining a window unit to a frame.

FIG. 7 shows a coupling configuration for joining a door unit to a frame.

FIG. 8 is a schematic illustration of compound fenestration assemblies according to the present invention.

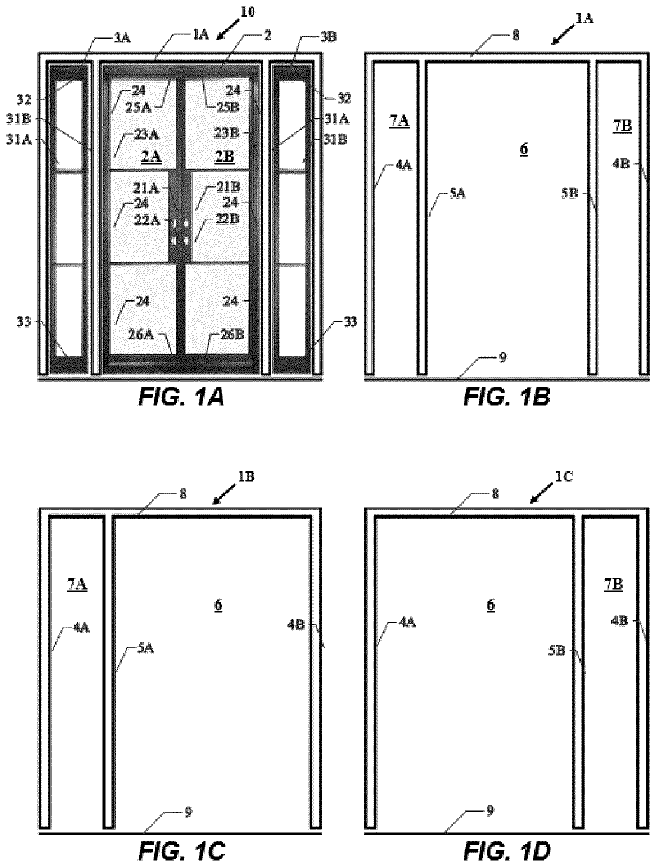

### DETAILED DESCRIPTION OF THE INVENTION

The following disclosure discusses the present invention with reference to the examples shown in the accompanying drawings, though does not limit the invention to those examples.

The use of any and all examples, or exemplary language (e.g., “such as”) provided herein is intended merely to better illuminate the invention and does not pose a limitation on the scope of the invention unless otherwise claimed. No language in the specification should be construed as indicating any non-claimed element as essential or otherwise critical to the practice of the invention, unless otherwise made clear in context.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements.

Use of the terms “about” or “approximately” are intended to describe values above and/or below a stated value or range, as would be understood by one having ordinary skill in the art in the respective context. In some instances, this may encompass values in a range of approx. +/−10%; in other instances, there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context.

The term “fenestration,” as used herein, refers to structures that serve as closures to openings in buildings and other standing structures. Such structures include, though are not limited to, doors and windows. Fenestrations as addressed by the present application include those that may serve as closures to openings in other structures, including closures of openings to building envelopes (e.g., houses and office buildings), as well as closures of openings to free-standing structures (e.g., walls, fences, and gates). A compound fenestration may refer to any combination of one or more doors and/or one or more windows.

Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted.

The present invention is inclusive of a modular fenestration system adapted for selective assembly of compound fenestrations within simple quadrilateral frames, without need for a composite frame having intermediate posts or beams (e.g., mullposts, transom beams) between the individual fenestration modules. The fenestration modules are adapted for joining to one another via module adapters that enabling direct joining of adjacent fenestration modules via fasteners without need for intermediate posts therebetween, and which enable the ready disassembly and configuration of the compound fenestration without need for altering a pre-installed frame.

The present invention is described in detail with reference to compound fenestrations illustrated in the drawings that combine one or more doors with one or more windows. It will be understood that these are non-limiting examples of a compound fenestration according to the present invention, and that the present invention is equally applicable to any chosen combination of one or more doors and/or one or more windows.

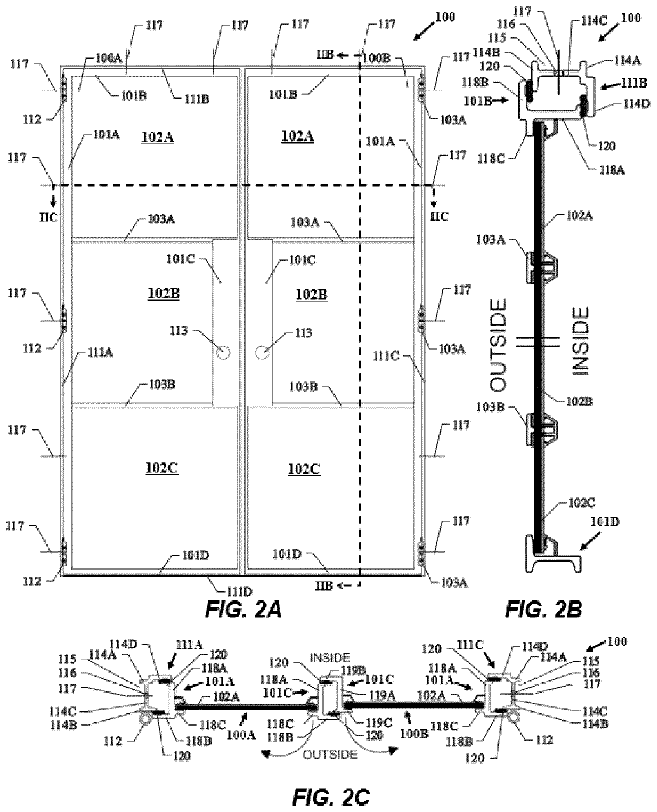

FIGS. 2A-2C show an example of a door unit 100 according to the present invention. FIG. 2A shows a front elevation view of the door unit 100, as seen from an outside thereof-e.g., a side intended for positioning at an exterior of a dwelling upon installation. FIG. 2B shows a cross-sectional view of the door unit 100 as seen along line IIB in FIG. 2A, and FIG. 2C shows a cross-sectional view of the door unit 100 as seen along line IIC in FIG. 2A. The individual views are not to scale with one another, and FIG. 2B is a condensed view that omits a middle region and the threshold of the door unit 100.

The door unit 100 in the illustrated example is a double-door unit having two swinging door slabs 100A/100B. Each door slab has a perimeter 101 defining an outer boundary thereof, composed of a vertical hinge stile 101A, a vertical lock stile 101C, a top rail 101B extending between upper ends of the vertical stiles 101A/101C, and a bottom rail 101D extending between lower ends of the vertical stiles 101A/101C. The perimeter 101 also defines an inner region of each door slab 100A/100B where a number of panels 102A/102B/102C are provided in series with a number of horizontal midrails 103A/103B therebetween. The panels 102A/102B/102C may be provided as monolithic extensions of the perimeter 101, with a recessed depth relative to the perimeter 101, or may be provided as separate components inserted into cavities defined within the perimeter 101. The panels 102A/102B/102C may be any chosen material type, including translucent panels (e.g., glass, plastic, etc.) or opaque panels (e.g., wood, metal, etc.). In some examples, the panels 102A/102B/102C may in fact be a single panel with the midrails 103A/103B formed over the surface or through openings in the single panel. In some examples, there may be no panels between the midrails 103A/103B such that the door slabs 100A/100B are constructed as open-air frames.

The door unit 100 has a door frame 110 composed of two vertical jambs 111A/111C, a header 111B extending between upper ends of the jambs 111A/111C, and a threshold 111D extending between lower ends of the jambs 111A/111C. The door slabs 100A/100B are mounted to the jambs 111A/111C via hinges 112 provided at the hinge stiles 101A of the respective door slabs 100A/100B As a double-door 100, the lock stiles 101C of the respective door slabs 100A/100B are provided with mating lock mechanisms 113 adapted for engaging one another for securing the door slabs 100A/100B in a closed position. In other examples, the door unit 100 may be a single door, with a single hinge stile mounted to one of the two jambs 111A/111C and a locking mechanism at a single lock stile adapted for engaging a mating lock mechanism at the other of the two jambs 111C/111A for securing the door slab in a closed position.

The vertical jambs 111A/111C and header 111B of the door frame 110 are each formed with a beam configuration having a first lateral flange 114A and a second lateral flange 114B separated by distal web 114C. The lateral flanges 114A/114B extend at equal distances toward an exterior side of the door frame 110, forming a symmetrical channel 115 along the outer perimeter of the beam configuration with the distal web 114C. The lateral flanges 114A/114B extend at inequal distances toward an interior side of the door frame 110, with the first lateral flange 114A having a lip 114D that extends further toward an interior of the door frame 110 relative to the second lateral flange 114B. A number of through-holes 116 are provided in the distal web 114C, extending from an interior-to-exterior direction, for reception of a number of corresponding fasteners 117. The threshold (not shown) may be formed as a flat beam.

The hinge stiles 101A and top rails 101B of the door slabs 100A/100B are each formed with a beam configuration having a distal web 118A with a lateral flange 118B and a lateral ledge 118C formed at one end of the distal web 118A, with the lateral flange 118B formed at a terminal end of the distal web 118A and extending a relatively longer distance toward an exterior of the door slab 100A/100B as compared to the lateral ledge 118C that is formed at a relatively inset end of the distal web 118A and extending a relatively shorter distance toward an interior of the door slab 110A/100B. The lock stile 101C of one door slab 100A is formed with a beam construction identical to that of the hinge stiles 101A and top rails 101B. The lock stile of the second door slab 100B is formed with a beam configuration having a distal web 119A, with a lateral flange 119B at one end and a lateral ledge 119C at the other end of the distal web 119A. The lateral flange 119B extends in a first direction at a relatively longer length as compared to the lateral ledge 119C that extends in a second, opposite direction and at a relatively shorter length.

The door slabs 100A/100B are pivotably mounted to the respective jambs 111A/111C via the hinges 112 which are installed with mating surfaces (e.g., strike plates) mounted to opposing surfaces of the hinge stiles 101A and respective jambs 111A/111C. When the door slabs 100A/100B are in a closed position, a surface of the lateral flange 118B of the hinge stile 101A rests in opposition to a surface of the second lateral flange 114B of the jamb 111A/111C, and the distal web 118A of the hinge stile 101A rests in opposition to the lip 114D of the hinge stile 111A/111C. Likewise, when the door slabs 100A/100C are in a closed position, a surface of the lateral flange 118B of the top rails 101B rests in opposition to a surface of the second lateral flange 114B of the header 111B, and the distal web 118A of the top rails 101B rest in opposition to the lip 114D of the header 111B. Also, when the door slabs 100A/100B are in a closed position, the distal web 118A/119A of one lock stile 101C rests in opposition to the lateral flange 119B/118B of the other lock stile 101C. Weather strips 120 are provided between the several opposing surfaces of the door slabs 100A/100B and door frame 110.

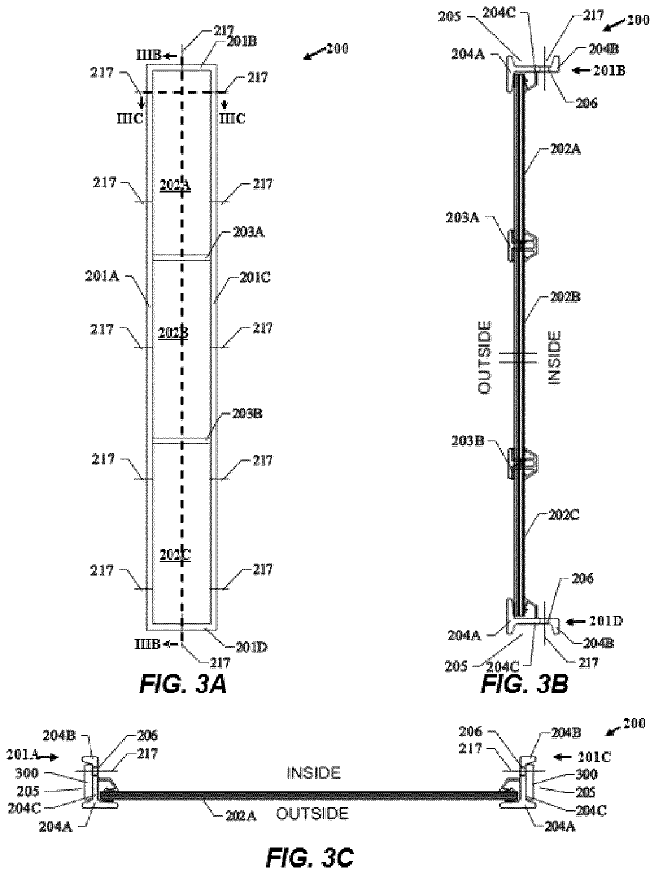

FIGS. 3A-3C show an example of a window unit 200 in the form of a sidelite 200 according to the present invention. FIG. 3A shows a front elevation view of the sidelite 200, as seen from an outside thereof-e.g., a side intended for positioning at an exterior of a dwelling upon installation. FIG. 3B shows a cross-sectional view of the sidelite 200 as seen along line IIIB in FIG. 3A, and FIG. 3C shows a cross-sectional view of the sidelite 200 as seen along line IIIC in FIG. 3A. The individual views are not to scale with one another and FIG. 3B is a condensed view that omits a middle region of the sidelite 200.

The sidelite 200 has a perimeter 201 defining an outer boundary thereof composed of a pair of vertical stiles 201A/201C, a top rail 201B extending between upper ends of the vertical stiles 201A/201C, and a bottom rail 201D extending between lower ends of the vertical stiles 201A/201C. The perimeter 201 also defines an inner region of the sidelite 200 where a number of panels 202A/202B/202C are provided in series with a number of horizontal midrails 203A/203B therebetween.

The panels 202A/202B/202C may be provided as monolithic extensions of the perimeter 201, with a recessed depth relative to the perimeter 201, or may be provided as separate components inserted into cavities defined within the perimeter 201. The panels 202A/202B/202C may be any chosen material type, including translucent panels (e.g., glass, plastic, etc.) or opaque panels (e.g., wood, metal, etc.), for example, if the sidelite 200 is intended for use as a decorative surface as opposed to a window surface. In some examples, the panels 202A/202B/202C may in fact be a single panel with the midrails 203A/203B formed over the surface of the panel. In some examples, there may be no panels between the midrails 203A/203B such that the sidelite 200 is constructed as an open-air frame.

The vertical stiles 201A/201C, top rail 201B, and bottom rail 201D of the sidelite 200 are each formed with a beam configuration having a first lateral flange 204A and a second lateral flange 204B separated by distal web 204C. The first lateral flange 204A is asymmetric in that it extends a first shorter distance to the exterior of the sidelite 200 and a second longer distance to the interior of the sidelite 200. The second lateral flange 204B is also asymmetric in that it extends only in the exterior direction from the sidelite 200. The first and second flanges 204A/204B extend at equal distances toward the exterior side of the sidelite 200, forming a symmetrical channel 205 along the outer perimeter of the beam configuration with the distal web 204C. A number of through-holes 206 are provided in the distal web 204C, extending from an interior-to-exterior direction, for reception of a number of corresponding fasteners 217.

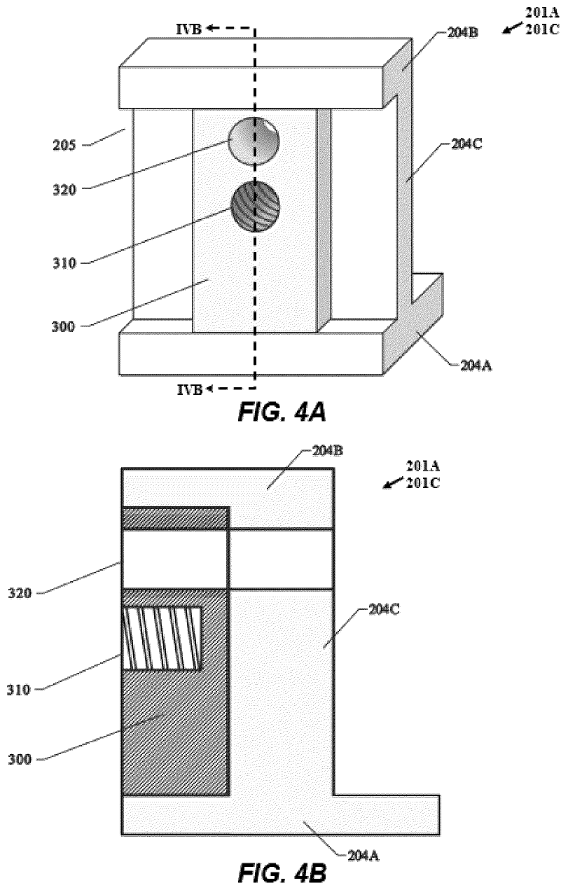

Module couplers 300 are inserted in the channels 205 formed along the vertical stiles 201A/201C of the sidelite 200 at locations corresponding with the through-holes 206 formed in the distal web 204C of the respective vertical stile 201A/201C. FIG. 4A shows a close-up of a module coupler 300 in a channel 205, and FIG. 4B shows a cross-section view of the module coupler 300 as seen along line IVB in FIG. 4A. The module coupler 300 has two holes, with a central threaded blind hole 310 and an offset smooth (non-threaded) through-hole 320.

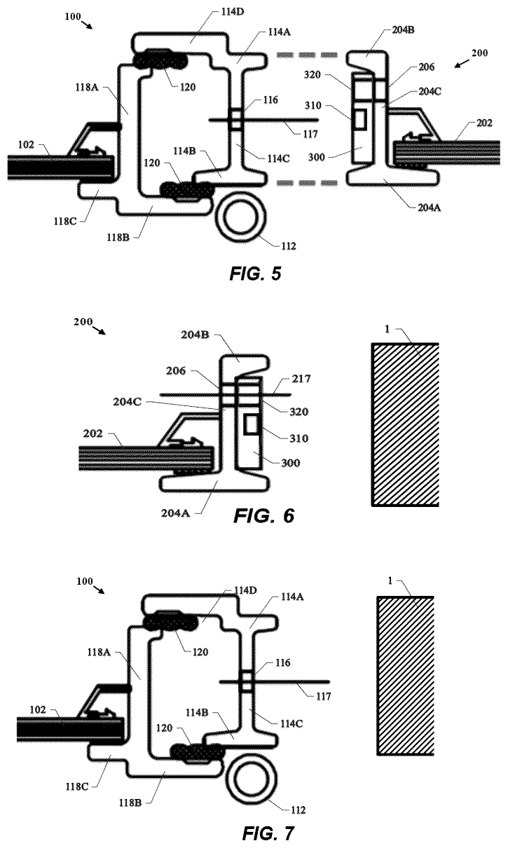

The blind hole 310 is centrally positioned to align with the centrally aligned through-holes 116 provided through the distal webs 114C of the jambs 111A/111C of the door unit 100, and the through-hole 320 is offset to align with the offset through-holes 206 provided through the distal webs 204C of the vertical stiles 201A/201C of the sidelite 200. FIGS. 5-6 show two coupling configurations for use when assembling a compound fenestration 10 that includes the joining of a door unit 100 and a window unit 200. FIG. 5 shows a coupling configuration for joining a door unit 100 directly to a window unit 200, with a fastener 117 inserted through a centrally aligned through-hole 116 in a jamb 111A/111C of the door unit 100 and threaded into the blind hole 310 of the module coupler 300 at the window unit 200. This connection enables direct joining of the door unit 100 and the sidelite 200 without need for an intermediate mullpost therebetween.

FIG. 6 shows a coupling configuration for joining a window unit 200 directly to a frame 1 in a rough opening of a structure, with a fastener 217 inserted through both the through-hole 206 in a stile 201A/201C of the window unit 200 and the through-hole 320 in the module coupler 300 for threading directly into the frame 1. FIG. 7 shows a coupling configuration for joining a door unit 100 directly to a frame 1 in a rough opening of a structure, with a fastener 117 inserted through the through-hole 116 in a jamb 111A/111C or header 111B of the door frame 110 for threading directly into the frame 1.

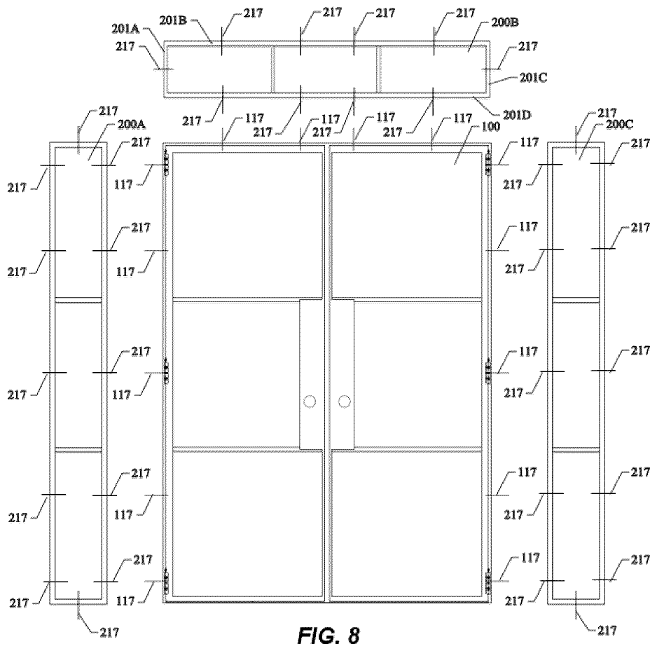

FIG. 8 presents a schematic illustration of potential configurations for a modular fenestration system according to the present invention. The illustrated example shows multiple modular units, including a door unit 100, in the form of a double-door, a first window unit 200A, in the form of a left-positioned sidelite, a second window unit 200B, in the form of an overhead transom, and a third window unit 200C, in the form of a right-positioned sidelite. With such a modular fenestration system, a single quadrilateral frame 1 may be constructed in a rough opening of a structure, without a mullpost or a transom beam, and any combination of fenestration modules may then be chosen for installation in the frame 1 based on the desired aesthetic appearance.

For example, a frame dimensioned for reception of a door unit 100 and a single sidelite 200 may receive a compound fenestration 10 with the sidelite 200 positioned at either the left or right of the door unit 100. Thereafter, the compound fenestration 10 may readily be reconfigured, for example to switch the sidelite from a left position 200A to a right position 200C, or vice versa, by removing and reinstalling the fenestration modules without need for altering the frame to include or adjust the position of a mullpost. In another example, a compound fenestration composed of a door unit 100 with a first height and a transom 200B of a first height may be removed and replaced with a door unit 100 of a second height and a transom 200B of a second height, effectively changing the relative heights of the two fenestration modules within the frame, without need to alter the frame to include or adjust the position of a transom beam. Similarly, a fenestration composed of a transom alone, without any window units, may be removed and replaced with a compound fenestration composed of a relatively shorter door unit 100 and a transom 200B positioned thereabove, without need for any alteration to the frame to include or adjust a transom beam.

It will be understood that a transom 200B, such as that shown in FIG. 8, may be constructed in the same manner as a sidelite 200A/200C as discussed earlier, with the only exception that the transom 200B is made with module couplers 300 installed in the channels 205 formed at the longer top and bottom rails 201B/201D of the transom 200B, without module couplers 300 provided at the shorter side rails 201A/201C. With such a configuration, the module couplers 300 at the bottom rail 201D of the transom 200B may engage the header 111B of the door frame 110 with the same coupling configuration illustrated in FIG. 5, and the module couplers 300 at the top rail 201B of the transom 200B may engage the frame with the same coupling configuration illustrated in FIG. 6. At any location where the door unit 100 is to engage the frame, the door frame 110 will engage the frame with the coupling configuration illustrated in FIG. 7.

Although the present invention is described with reference to particular embodiments, it will be understood to those skilled in the art that the foregoing disclosure addresses exemplary embodiments only; that the scope of the invention is not limited to the disclosed embodiments; and that the scope of the invention may encompass any combination of the disclosed embodiments, in whole or in part, as well as additional embodiments embracing various changes and modifications relative to the examples disclosed herein without departing from the scope of the invention as defined in the appended claims and equivalents thereto.

The foregoing discussion addresses a non-limiting example of the invention in which the door unit 100 is a double door and the window units 200A/200B/200C have heights (sidelites) or widths (transom) closely corresponding with the door unit 100. For example, the door unit 100 may have a height of approximately 84 inches and a width of approximately 60 inches; with the sidelites 200A/200C having heights of approximately 81 inches and widths of approximately 10 inches; and with the transom 200B having a height of approximately 10 inches and a width of approximately 57 inches. However, the invention is not limited to such configurations. For example, the door unit 100 may be a single door and the window units 200A/200B/200C may have dimensions differing from those of the door unit. For example, the sidelites 200A/200C may have heights that are only a fraction (one-half, one-third, one-fourth) that of the door unit 100, and the transom 200B may have a width that is only a fraction (one-half, one-third, one-fourth) that of the door unit 100.

Though the foregoing discussion addresses an example in which the door unit 100 and window units 200 are rectangular in shape, the invention is not limited to such configurations. Compound fenestrations according to the present invention may include door units 100 and window units 200 of other shapes, including though not limited to circular and oval shapes. Whereas the rectangular fenestration modules 100/200 in the example addressed above was discussed relative to rectangular components, such as vertical stiles and jambs, top rails and headers, and bottom rails and thresholds, it will be understood that fenestration modules according to the present invention may instead be discussed with reference to arcuate or other shaped stiles, jambs, rails, headers, and thresholds or simply with reference to a perimeter that may include all of the foregoing components or which may substitute for such components, for example, with a single arcuate perimeter rail for an oval or circular shaped fenestration module.

To the extent necessary to understand or complete the disclosure of the present invention, all publications, patents, and patent applications mentioned herein are expressly incorporated by reference herein to the same extent as though each were individually so incorporated.

The present invention is not limited to the exemplary embodiments illustrated herein, but is instead characterized by the appended claims, which in no way limit the scope of the disclosure.

1. A modular fenestration system comprising:
a first fenestration module comprising a perimeter formed with a beam configuration having a distal web with a number of though-holes formed through the distal web, the number of through-holes having a first alignment;
a second fenestration module comprising a perimeter formed with a beam configuration having a distal web with a number of though-holes formed through the distal web, the number of through-holes having a second alignment differing from the first alignment; wherein
a number of module couplers are affixed along the perimeter of at least the second fenestration module, the module couplers having through-holes therethrough and positioned such that the though-holes in the module couplers are aligned with the through-holes in the distal web of the second fenestration module having the second alignment, the module couplers adapted for releasably joining the first fenestration module directly to the second fenestration module.

2. The modular fenestration system according to claim 1, wherein
the module couplers have blind holes therein and are positioned such that the blind holes in the module couplers are aligned with the through-holes in the distal web of the first fenestration module having the first alignment.

3. The modular fenestration system according to claim 2, wherein
the blind holes in the modular couplers comprise internal threading for releasable reception of a matingly threaded fasteners.

4. The modular fenestration system according to claim 1, wherein
the through-holes in the module couplers are non-threaded for unhindered passage of fasteners therethrough.

5. The modular fenestration system according to claim 2, wherein
the module couplers are configured for releasably joining the first fenestration module to the second fenestration module via reception of fasteners that pass through the through-holes in the first fenestration module and are secured within the blind holes of the module couplers.

6. The modular fenestration system according to claim 1, wherein
the module couplers are configured for releasably joining the second fenestration module to a frame in a rough opening of a structure via reception of fasteners that pass through the through-holes in the second fenestration module, pass through the through-holes in the module couplers, and are secured at the frame.

7. The modular fenestration system according to claim 1, wherein
at least one of the fenestration modules is a door unit and the other of the fenestration modules is a window unit.

8. The modular fenestration system according to claim 7, wherein
the window unit is a sidelite adapted for releasably joining directly with the door unit, selectively, at both a lateral left position and a lateral right position of the door unit.

9. The modular fenestration system according to claim 7, wherein
the window unit is a transom adapted for releasably joining directly with the door unit at a vertical position of the door unit.

10. A method of assembling a compound fenestration, comprising:
utilizing a modular fenestration system according to claim 1, joining the first fenestration module directly to the second fenestration module via a coupling configuration at the module coupler.

11. The method according to claim 10, wherein
the joined first fenestration and second fenestration are secured in a pre-installed frame within a rough opening of a structure, the frame being free of an intermediate post or beam for positioning between the first fenestration and the second fenestration.

12. The method according to claim 11, wherein
the assembled compound fenestration is adapted for selective reconfiguration, enabling repositioning of the relative positions of the first fenestration and the second fenestration within the frame without need for alteration to the frame.

13. The method according to claim 12, wherein
the assembled compound fenestration is adapted for selective reconfiguration, enabling reconfiguration from a door unit with a single window unit installed as a left-positioned sidelite to a door unit with a single window unit installed as a right-positioned sidelite.
